(19) United States
(12) Patent Application Publication
(10) Pub. No.: US 2026/0072128 A1
(43) Pub. Date: Mar. 12, 2026

(54) SENSOR SYSTEMS, METHODS, AND INSTRUCTIONS TO OPERATE WITH MULTIPLE CLOCK FREQUENCIES

(71) Applicant: Texas Instruments Incorporated, Dallas, TX (US)

(72) Inventors: Karthik Subburaj, Bangalore (IN); Vashishth Shounak Dudhia, Bengaluru (IN); Shankar Ram Narayana Moorthy, Bangalore (IN); Rakesh Raavi, Bengaluru (IN)

(21) Appl. No.: 18/927,262

(22) Filed: Oct. 25, 2024

(30) Foreign Application Priority Data
Sep. 5, 2024 (IN) 202441067207

(51) Int. Cl. G01S 7/35; G01S 13/58

(52) U.S. Cl. CPC G01S 7/354; G01S 13/584

(57) ABSTRACT

Methods, apparatus, systems, and articles of manufacture are described corresponding to a sensor system operating with multiple clock frequencies. An example system includes a radio frequency (RF) phase-locked loop (PLL) to generate an output signal at a first frequency; a microcontroller to operate at a second frequency, the first frequency being a multiple of the second frequency; a transmitter to output a chirp signal with a chirp period selected based on the second frequency; a receiver to receive a reflected signal corresponding to the chirp signal; and a filter to filter out a doppler bin corresponding to the reflected signal based on the chirp period.

### CROSS-REFERENCE TO RELATED APPLICATION

This patent application claims the benefit of and priority to Indian Provisional Patent Application No. 202441067447, filed Sep. 6, 2024, which is hereby incorporated herein by reference in its entirety.

### TECHNICAL FIELD

This description relates generally to computing devices, and, more particularly, to sensor systems, methods and instructions to operate with multiple clock frequencies.

### BACKGROUND

Manufacturers of integrated circuits (ICs) have developed techniques to fabricate compact ICs that incorporate components of a computer or other electronic system. Such ICs are referred to as Systems on a Chip, or SoCs. Such SoCs include transceivers, processor cores, memory, input/output ports and secondary storage, all on the same substrate or in the same package. Depending on the application, a SoC may include digital, analog, mixed-signal, radio frequency (RF), or other signal processing functions.

Some SoCs include radar components. Radar components enable object detection in any number of environments. The automobile industry includes radar components in some vehicles to enable improved safety features, such as driver attention monitoring, object avoidance, emergency braking, etc.

### SUMMARY

For a sensor system operating with multiple clock frequencies, an example apparatus includes a radio frequency (RF) phase-locked loop (PLL) to generate an output signal at a first frequency; a microcontroller to operate at a second frequency, the first frequency being a multiple of the second frequency; a transmitter to output a chirp signal with a chirp period selected based on the second frequency; a receiver to receive a reflected signal corresponding to the chirp signal; and a filter to filter out a doppler bin corresponding to the reflected signal based on the chirp period. Other examples are described.

For a sensor system operating with multiple clock frequencies, an example method includes generating an output signal at a first frequency; operating a core at a second frequency, the first frequency being a multiple of the second frequency; outputting a chirp signal with a chirp period selected based on the second frequency; receiving a reflected signal corresponding to the chirp signal; and filtering out a doppler bin corresponding to the reflected signal based on the chirp period. Other examples are described.

For a sensor system operating with multiple clock frequencies, an example instructions cause at least one programmable circuit to select a first frequency of a first clock signal to be generated by a radio frequency (RF) phase-locked loop (PLL), the first clock signal used to generate a second clock signal at a second frequency, the first frequency selected based on harmonics of the first clock signal and harmonics of the second clock signal; select a chirp period of a chirp signal to be output by a transmitter of radar, the chirp period of the chirp signal based on the second frequency of the second clock signal; cause a phase-locked loop to generate the first clock signal at the first frequency; and cause a transceiver to output the chirp signal based on the selected period. Other examples are described.

### BRIEF DESCRIPTION OF THE DRAWINGS

FIG. 1 illustrates an example system on chip to implement radar in conjunction with examples described herein.

FIG. 2 is an alternative system on chip to implement radar in conjunction with examples described herein.

FIGS. 3-5 illustrates a flowchart representative of hardware operation, example machine readable instructions or example operations that may be executed, instantiated, or performed by example programmable circuitry to implement the system on chip of FIG. 1 or 2.

FIG. 6A illustrates example range doppler representations corresponding to a ghost target that exist based on a mismatch corresponding to the frequency of the clock signal generated by an oscillator and the clock signal used by a processor core of the system on chip.

FIG. 6B illustrates example range doppler representations corresponding to a ghost target that has been moved to a maximum doppler bin using examples described herein to be able to filter out the ghost target.

FIG. 6C illustrates an alternative example range doppler representations corresponding to a ghost target that has been moved to a zero doppler bin using examples described herein to be able to filter out the ghost target.

FIG. 7 illustrates an example chirp signal that is output by the system on chip of FIG. 1 or 2.

FIG. 8 is a block diagram of an example processing platform including programmable circuitry structured to execute, instantiate, or perform the example machine readable instructions or perform the example operations of FIGS. 3-5 to implement the system on chip of FIG. 1 or 2.

FIG. 9 is a block diagram of an example software/firmware/instructions distribution platform (e.g., one or more servers) to distribute software, instructions, or firmware (e.g., corresponding to the example machine readable instructions of FIGS. 3-5) to client devices associated with end users or consumers (e.g., for license, sale, or use), retailers (e.g., for sale, re-sale, license, or sub-license), or original equipment manufacturers (OEMs) (e.g., for inclusion in products to be distributed to, for example, retailers or to other end users such as direct buy customers).

The same reference numbers or other reference designators are used in the drawings to designate the same or similar (functionally or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines or boundaries may be idealized. In reality, the boundaries or lines may be unobservable, blended or irregular.

Radar systems typically utilize radar sensors to produce data used to detect obstacles, and measure distance, velocity, or direction corresponding to the obstacles. Radar systems may be utilized by any industry, including the automobile industry, that enables improved safety features (e.g., driver monitoring, object avoidance, emergency braking, etc.) and new autonomous driving features (e.g., navigation). Example radar systems may include, but are not limited to, system-on-a-chip (SoC) devices that communicate or otherwise interact with other processing devices to interpret radar data. In some examples, the SoC is in circuit with or otherwise in communication with processing devices to instantiate warning or informational prompts regarding obstacle parameters in view of proximity limits, processing devices to facilitate user interaction/interface, etc.

Radar systems operate by transmitting a chirp signal via an antenna. As used herein, a “chirp signal,” a “chirp,” a “radar chirp,” or a “radar signal” is a analog signal, which is typically transmitted repeatedly over a set time period (e.g., in a frame) that represents radar information/data. If an object is in the path of transmitted chirp signal, the chirp signal is reflected back to an antenna of the radar system. Generally speaking, a reflected radar chirp is received or otherwise detected by the radar system and digitized to generate sample data. As used herein, “sample data” or a “sample” is digitized output from one or more analog-to-digital converters (ADCs), and such sample data may be stored in memory. Also, the radar systems can include processor cores to process the sample data in connection with one or more signal processing techniques, such as a Fast Fourier Transform (FFT) to generate processed radar data, which results from sample data that has been modified in connection with one or more digital signal processing (DSP) techniques or algorithms.

In some examples, a range FFT is performed on sample data corresponding to reflected chirps to convert the sample data to a frequency domain representation. Peak values correspond to ranges (distances) of objects, and such range FFT processing may be performed on sample data corresponding to a previous chirp while other sample data are being collected corresponding to a current chirp (e.g., sometimes referred to as in-line processing). Results of a range FFT may be stored in memory for further processing (e.g., processing to generate Doppler FFT or Angle FFT data).

Some radar systems have been designed to operate using one or more clock signals having particular frequencies that avoid the occurrence of ghost targets. A ghost target is a target that appears on a Doppler FFT but is not actually present. If ghost targets appear in the Doppler FFT, the radar system informs processing circuitry or a user that an object is present at a particular distance or moving at a particular speed but that object is not actually there. The presence of ghost targets is based on a mismatch corresponding to frequencies of different clock signals used by components in the radar system. For example, a ghost target may appear if the M(MCU_CLK)≠N(XTAL_CLK), where M is an integer value, N is an integer value, MCU_CLK is the frequency of the clock applied to the microcontroller core of the radar system, and XTAL_CLK is the frequency of the clock generated by an oscillator that generates all clock signals for the radar system. The ghost target appears, if, for some values of M and N, the frequency M(MCU_CLK)−N(XTAL_CLK) is between 0 and the supported intermediate frequency (IF) bandwidth of the radar device (e.g., 10 MHz). In a given example, for M=5 and N=1, then 0≤M(MCU_CLK)−N(XTAL_CLK)≤10 Mhz. Some radar systems select the clock signal for the microcontroller core so that M(MCU_CLK)=N(XTAL_CLK), so that no ghost target appears.

However, the frequency of the clock signal used by the MCU core may need to be adjusted to avoid restricted frequency bands or conserve energy. For example, if the frequency of the clock signal used by the MCU is 200 Megahertz (MHz), then the MCU will generate emissions at the 200 MHz frequency and harmonics (e.g., multiples) of the 200 MHz frequency (e.g., 400 MHz, 600 MHz, 800 MHz, . . . ). If there is a standard that restricts electromagnetic emissions within a particular narrow band (e.g., 1.6 GHZ), the radar may be restricted from operating the MCU at the 200 MHz frequency because 1.6 GHz is a harmonic of 200 MHz (e.g., 200 MHz*8=1.6 GHZ). Thus, the radar system will generate emissions in the restricted frequency band. Adjusting the frequency of the clock signal(s) to avoid the restricted frequency band results in the appearance of a ghost target in the Doppler FFT.

To avoid generating emissions in a restricted frequency band, examples described herein adjust the frequency of a radio frequency (RF) phase-locked loop (PLL) that generates clock signals at different frequencies for the different components of the radar system. For example, the RF PLL converts a clock signal of a first frequency (e.g., 40 MHz) from an oscillator circuitry into a high frequency clock signal (e.g., around 14.4 GHZ). The output of the RF PLL is divided by one or more integer amounts to generate clock signals of different frequencies for the different components of the radar system. For example, the 14.4 GHz signal is divided by 72 to generate the 200 MHz signal applied to the MCU core. Accordingly, if the emitted harmonics of the MCU core is within a restricted frequency band, examples described herein adjust the frequency of the output of the RF PLL, adjusting the frequency of the clock signal used by the MCU, which also adjusts the harmonics. For example, if the restricted frequency band is 1.6 GHZ, the RF PLL can output a clock signal at 14.32 GHZ (e.g., instead of 14.4 GHZ), causing the MCU core to operate based on a 198.89 MHz frequency. Because the harmonics of the 198.89 MHz clock signal for the MCU core is outside of the 1.6 GHz band (e.g., 198.89 MHz*8=1.59 GHZ, which is outside the 1.6 GHz band), the harmonics of the MCU core no longer cause emissions within the restricted 1.6 GHz band.

Although adjusting the frequency of the clock signal output by the RF PLL results in harmonics outside of a restricted frequency band, adjusting the frequency of the clock signal used by the MCU causes M(MCU_CLK)≠N(XTAL_CLK). As described above, if M(MCU_CLK)≠N(XTAL_CLK), then a ghost target will appear at a range offset of M(MCU_CLK)−N(XTAL_CLK) on the ranger doppler representations (e.g., due to coexistence of the several components of the radar system operating at different frequencies). Examples described herein adjust the period of the chirp to cause the ghost target to move to a particular doppler bin (also referred to as a range-doppler bin) so that the ghost target can be filtered out. Examples described herein may adjust the period of the chirp signal to cause the ghost target to appear at the maximum positive or negative doppler of the doppler representation or at the zero doppler of the doppler representation. By moving the ghost target to a predefined doppler bin, examples described herein can filter out the doppler bins at the predefined frequency to remove the ghost target. As used herein, a doppler bin is a direct representation of the velocity of an object. Zero doppler bin means that the object is static relative to the radar system and a high doppler bin indicates that the object is moving with a high velocity relative to the radar system. Accordingly, examples described herein adjust clock signal frequencies to avoid generating emissions within restricted bands while mitigating ghost targets that result from the adjusted clock signal frequencies. Although examples described herein adjust clock frequencies to avoid restricted frequency bands, examples described herein may adjust clock frequencies to support lower clock frequency operation to increase power savings.

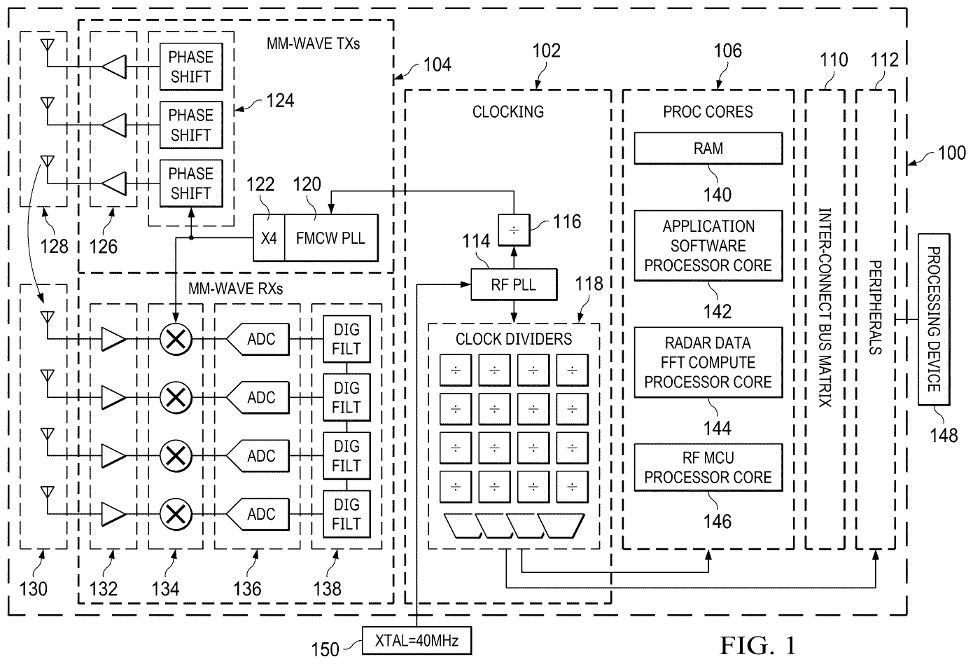

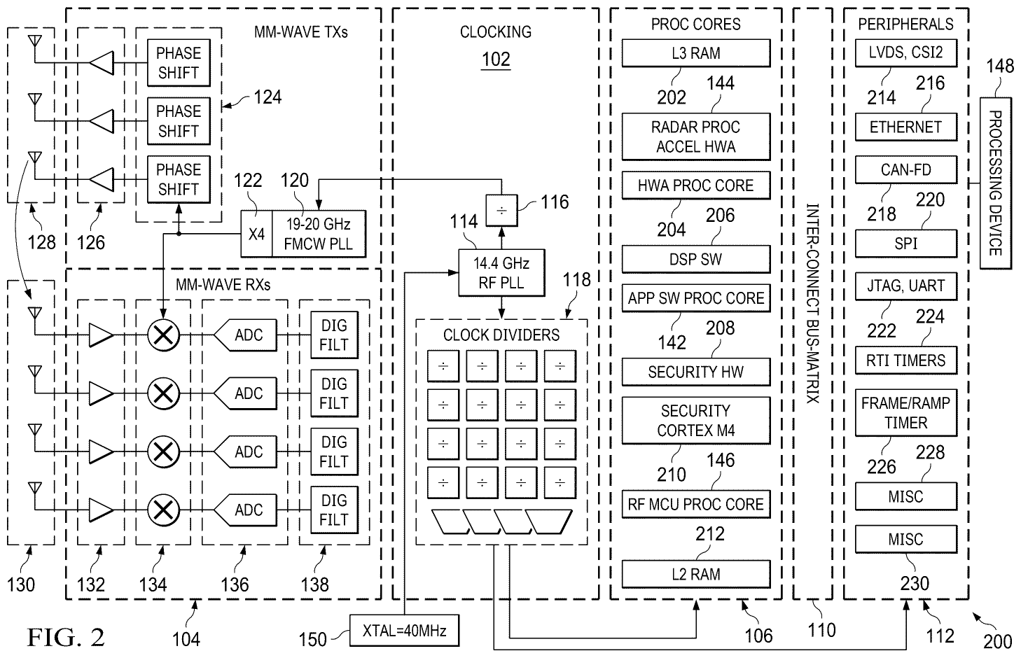

FIG. 1 illustrates an example radar system 100 that can detect objects or velocity of objects by transmitting a signal and analyzes reflected signals. The radar system 100 includes example clocking circuitry 102, an example transceiver 104, example processor cores 106, an example inter-connect bus matrix 110, and example peripheral components 112. The clocking circuitry includes an example radio frequency (RF) phase-locked look (PLL) 114, and example divider circuitries 116, 118. The transceiver 104 includes an example frequency-modulated continuous-wave (FMCW) PLL 120, an example frequency multiplier 122, example phase shift circuitry 124, example amplifiers 126, 132, example antennas 128, 130, example mixer circuitries 134, example analog-to-digital converters (ADCs) 136, and example digital filters 138. The example processor cores 106 include an example random access memory 140, an example application software processor core 142, an example radar data Fourier transform (FFT) compute processor core 144, and an example RF microcontroller processor core 146. FIG. 1 further includes a processing device 148 and an example oscillator 150. The processor cores 106 may include additional or alternative cores as further described below in conjunction with FIG. 2.

The radar system 100 of FIG. 1 may be a system on chip that includes multiple components to detect objects or velocity of objects by transmitting a signal and analyzes reflected signals. The clocking circuitry 102 of the radar system 100 obtains a clock signal from the oscillator 150 at a particular frequency (e.g., 40 MHz) and converts the clock signal into multiple other clock signals at different frequencies to be applied to other components of the radar system 100. The RF PLL 114 is control circuitry that increases the frequency of the clock signal output by the oscillator 150 by multiplying it with an integer to produce a high-frequency clock (e.g., above 14 GHZ). In some examples, the oscillator 150 may be implemented in the processing device 148 or in the radar system 100. As further described below, the RF PLL 114 generates a particular high frequency clock signal that, when divided by the divider circuitry(ies) 116, 118 results in different clock signals that can be used by different components of the radar system 100. The RF PLL 114 generates the particular high frequency clock signal so that the harmonics of the different clock signals generated from the high frequency clock signal do not fall within a restricted frequency band. For example, if the 1.6 GHz frequency band is restricted, the RF PLL 114 will generate a high frequency clock signal that, when divided into lower frequency clock signals, does not result in harmonics within the 1.6 GHz frequency band. However, the RF PLL 114 cannot adjust the frequency of the generated clock signal by too much, as the components of the radar system 100 that rely on the generated clock signal may only operate within a particular range of frequencies. The RF PLL 114 outputs the generated high frequency clock signal to the divider circuitry 116, 118 to generate the lower frequency signals for other components of the radar system 100. The divider circuitries 116, 118 output/provide the lower frequency clock signals to the transceiver 104, one or more of the processor cores 106, or one or more of the peripherals 112 to use during operation.

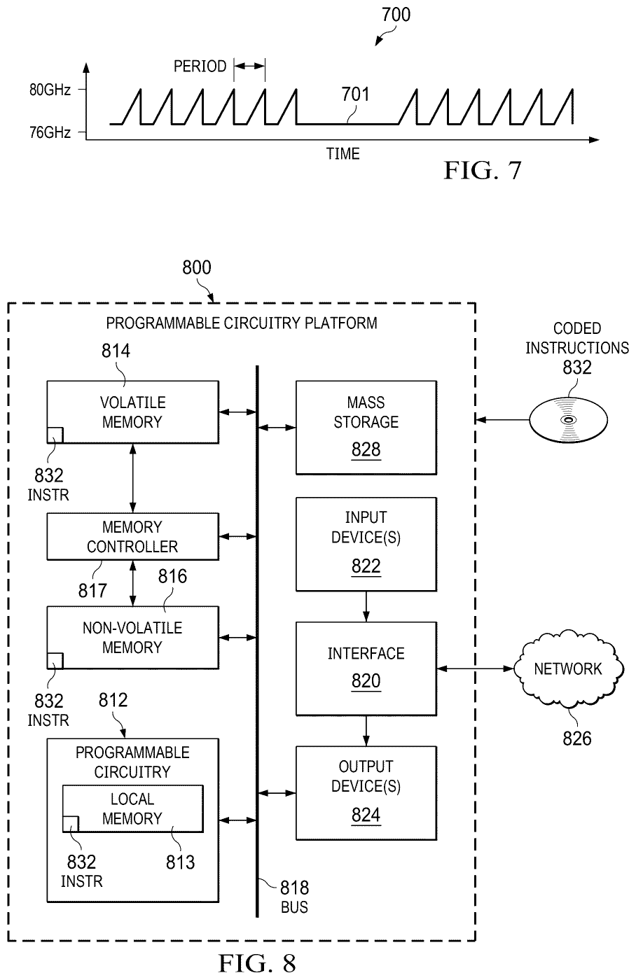

The FMCW PLL 120 of FIG. 1 obtains a clock signal from the divider 116 and generates a chirp signal based on the obtained clock signal. The chirp signal is a signal that increases or decreases between a first and second frequency over time. An example chirp signal is further described below in conjunction with FIG. 7. As described above, the period of the chirp signal (e.g., the chip periodicity) causes a ghost target (if one exists) to move to a predefined location within a doppler representation. For example, the FMCW PLL 120 generates a chirp signal with a particular period to ensure that a ghost target will appear at a maximum velocity range that the radar system 100 can identify or at a zero velocity. The below equation 1 illustrates where a ghost target will appear.

$${ghost\_target}_{range \_ offset} = M ( MCU\_CLK ) - N ( XTAL\_CLK ) \qquad ( Equation 1 )$$

In the above-Equation 1, the ghost_target_{range_offset} is the range frequency offset of the ghost target from the actual objects in a range doppler representation of actual objects, M is an integer value (e.g., 1), N is an integer value (e.g., 5), MCU_CLK is the frequency of the clock signal used by the RF MCU processor core 146, and XTAL_CLK is the frequency of the clock signal generated by the oscillator 150. To adjust the doppler bin of the ghost target, the FMCW PLL 120 adjusts the period of the chirp to R(1/(2*ghost_target_{range_offset})), where R is an integer. If R is an odd integer, the doppler of the ghost target is moved to the maximum doppler frequency (e.g., the maximum positive or negative doppler frequency) that the radar system 100 is structured to detect (e.g., corresponding to a high velocity detected object). If R is an even integer, the doppler of the ghost target is moved to the zero doppler frequency (e.g., corresponding to an identified object that is not moving). As further described below, the frequency offset corresponds to a range difference between a ghost object and an actual object. In this manner, because the ghost target appears at a predefined doppler bin, the doppler bin can be filtered out to remove the ghost target.

The multiplier circuitry 122 of FIG. 1 multiplies the frequency of the FMCW PLL 120 to increase the frequency chirp signal generated by the FMCW PLL 120 to a range of frequencies, which range may be determined prior to operation. The multiplier circuitry 122 outputs the final chirp signal to the phase shift circuitries 124 and the mixer circuitries 134. The phase shift circuitries 124 adjust the phase of the chirp signal output by the multiplier circuitry 122. The phase shift circuitries 124 output the phase shifted chirp signal to the amplifiers 126. The amplifiers 126 may be power amplifiers that amplify the phase shifted chirp signals from the phase shift circuitries 124 and output the amplified, phase shifted chirp signals to the antennas 128. The antennas 128 output the chirp signal. If the chirp signal reaches an object, the signal will be reflected off the object and travel back to the radar system 100 (e.g., obtained via the antennas 130). In the illustrated example, there are three phase shifters 124 respectively coupled to three amplifiers 26, which are respectively coupled to three antennas 128, thus forming three transmit channels.

The antennas 130 of FIG. 1 receive the reflected chirp signals (e.g., the chirp signal output by the antenna 128 and reflected off of an object/target). The amplifiers 132 may be linear amplifiers that amplify the obtained reflected signal(s) and outputs the amplified reflected signal to the mixer circuitries 134. The mixer circuitries 134 mix signals received from the corresponding amplifier 132 with the signal output by the multiplier circuitry 122. For example, the mixer circuitries 134 may combine (e.g., add, subtract, etc.) the frequency of the chirp signal output by the multiplier 122 from the frequency of the reflected signal obtained by a respective antenna 130. Because the signal from the multiplier 122 was transmitted via the antennas 128 and then obtained via the antennas 130, there will be some delay in the obtained signal. The mixer circuitries 134 combine the obtained signal with the transmitted signal to generate an IF signal that corresponds to the amount of delay of the obtained signal, which corresponds to the distance to a detected object. The ADCs 136 convert the IF signal from the mixer circuitries 134 from analog signals to digital signals. The digital filter circuitries 138 filter the digital signals from the ADCs 136 to filter out objects that are too close or frequency content from far away that may not be of interest. The filtered signals are passed to one or more of the processor cores 106 to analyze or store the results. In the illustrated example, there are four receive channels, each including a respective one of four antennas 130, a respective one of four mixers 134, a respective one of four ADCs 136, and a respective one of four digital filters 138. Other examples may include more or less transmit and receive channels than shown in FIG. 1.

The results (e.g., samples) of the obtained signal are passed from the digital filters 138 to one or more of the processor cores 106. For example, the results may be stored in the RAM 140 or processed by the radar data FFT compute processor core 144 or the RF MCU processor core 146. The application software processor core 142 determines the frequency of the clock signal that the RF PLL 114 will generate. As described above, the frequency of the clock signal that the RF PLL 114 will generate is selected to ensure that the frequency of the clock signal, harmonics of the clock signal, the frequency(ies) of any one of the other clock signals generated by the divider circuitries 116, 118, or the harmonics of the other clock signals generated by the divider circuitries 116, 118 will not be within a restricted frequency band. Accordingly, the application software processor core 142 can determine a frequency for clock to be generated by RF PLL 114 so that the frequencies or harmonics of the multiple clock signals are outside the restricted frequency band(s). Additionally or alternatively, the application software processor core 142 can reduce the frequency of the clock generated by the RF PLL 114 for a lower power mode. After the application software processor core 142 selects the frequency of the clock signal to be generated by the RF PLL 114, the application software processor core 142 provides the instructions to the RF PLL 114 to generate the clock signal at the selected frequency. Also, the application software processor core 142 determines a range offset of a ghost target in a range doppler representation based on the above Equation 1. The application software processor core 142 selects a period for the chirp signal generated by the FMCW PLL 120 based on R(1/(2*ghost_target_{range_offset})), where R is an integer. As described above, if R is an odd integer, the doppler of the ghost target is moved to the maximum doppler frequency (e.g., the maximum positive or negative doppler frequency) that the radar system 100 is structured to detect (e.g., corresponding to a high velocity detected object). If R is an even integer, the doppler of the ghost target is moved to the zero doppler frequency (e.g., corresponding to an identified object that is not moving). After the application software processor core 142 selects the chirp period, the application software processor core 142 provides the instructions to the FMCW PLL 120 to generate the chirp signal based on the selected period.

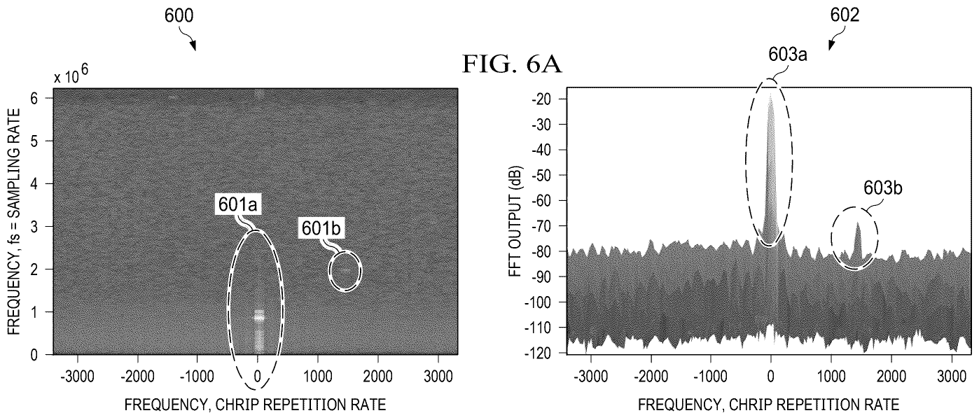

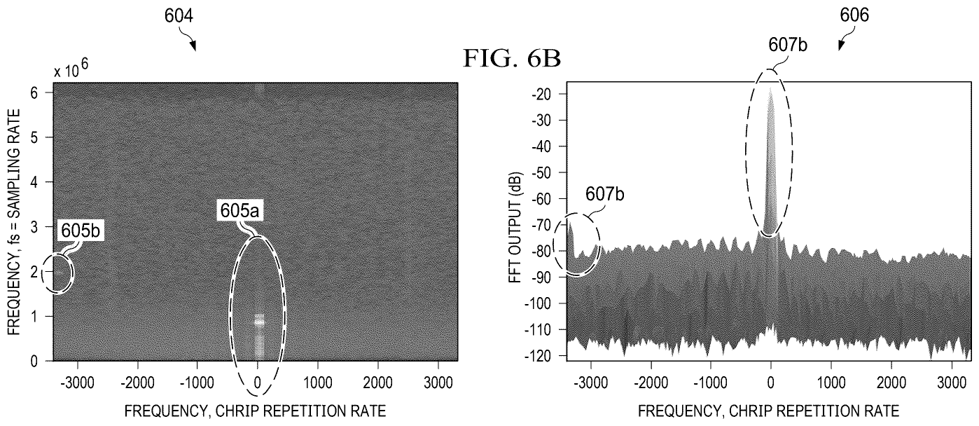

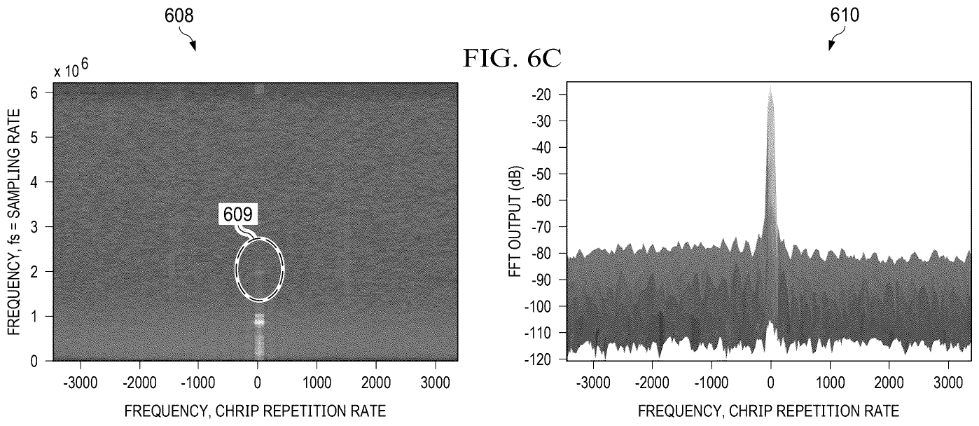

The radar data FFT compute processor core 144 of FIG. 1 may be a hardware accelerator that processes obtained samples from the RAM 140 or from the digital filters 138 to generate one or more range doppler representations of the samples. The one or more range doppler representations may include a range-doppler heat map or a doppler dimension FFT. The range doppler heatmap is a representation of a processed signal as a function of range and relative velocity. In a range doppler heatmap, identified objects appear as peaks in a heatmap, which corresponds to a distance from the radar system 100 and velocity of the object. An example visual representation of the range doppler heatmap is further described below in conjunction with FIGS. 6A-6C. A doppler dimension FFT corresponds to the frequency domain of the range doppler heatmap. The doppler dimension FFT plots detected objects and their corresponding doppler signature. An example visual representation of the doppler dimension FFT is further described below in conjunction with FIGS. 6A-6C.

The RF MCU processor core 146 of FIG. 1 controls operation of various components of the radar system 100. Also, the RF MCU processor core 146 can analyze the one or more range doppler representations generated by the radar FFT compute processor core 144. For example, the RF MCU processor core 146 can process the one or more range doppler representations to determine whether one or more objects have been detected or the velocity of the detected one or more objects. In some examples, the RF MCU processor core 146 can filter out a doppler bin (e.g., a range offset within the range doppler representations) based on the period of the chirp signal. As described above, the period of the chirp signal generated by the FMCW PLL 120 can be selected to cause a ghost target to be moved to a particular range offset (e.g., a maximum doppler bin or a zero-doppler bin). Accordingly, the RF MCU processor core 146 can filter out the bins in the range doppler representation(s) that correspond to the maximum doppler bin or the zero-doppler bin (based on the period of the chirp signal). In this manner, the ghost target generated by adjusting the RF PLL 114 will be filtered out. The RF MCU processor core 146 can output the processing analysis to the processing device 148 via the interconnect bus matrix 110 and the peripherals 112. The interconnect bus matrix 110 routes control or data signals to/from one or more of the processor cores 106 from/to the peripherals 112. The peripherals 112 are components that can interface with other components outside of the radar system 100. Examples of different peripherals are further described below in conjunction with FIG. 2.

The processing device 148 of FIG. 1 obtains the results of the RF MCU processor core 146 to perform one or more actions (e.g., generate alerts, perform auto driving functions, etc.) based on the results (e.g., the position or velocity of detected objects). In some examples, the processing device 148 may perform the filtering of the doppler bins of the range doppler representation(s). For example, instead of the RF MCU processor core 146 performing the filtering of the doppler bins that correspond to a ghost target, the processing device 148 may perform the filtering.

The oscillator 150 of FIG. 1 is a device that generates a clock signal at a particular frequency. For example, the oscillator 150 may be a crystal oscillator that generates a clock signal at 40 Mhz. The oscillator 150 outputs the clock signal to the RF PLL 114. As described above, the RF PLL 114 uses the clock signal to generate a higher frequency clock signal.

FIG. 2 illustrates an example radar system 200 that corresponds to the radar system 100 of FIG. 1 with additional processor cores and peripherals. The radar system 100 includes the example clocking circuitry 102, the example transceiver 104, the example processor cores 106, the example inter-connect bus matrix 110, and the example peripheral components 112 of FIG. 1. The clocking circuitry includes the example radio frequency (RF) phase-locked look (PLL) 114, and the example divider circuities 116, 118 of FIG. 1. The transceiver 104 includes the example frequency-modulated continuous-wave (FMCW) PLL 120, the example frequency multiplier 122, the example phase shift circuitry 124, the example amplifiers 126, 132, the example antennas 128, 130, the example mixer circuitries 134, the example analog-to-digital converters (ADCs) 136, and the example digital filters 138 of FIG. 1. The example processor cores 106 include the example application software processor core 142, the example radar data Fourier transform (FFT) compute processor core 144, and the example RF microcontroller processor core 146 of FIG. 1. FIG. 2 further includes the processing device 148 and the example oscillator 150 of FIG. 1. The processor cores 106 of FIG. 2 further includes an example level 2 (L2) RAM 202, an example hardware accelerator processor core 204, an example digital signal processor software core 206, an example security hardware core 208, example security cortex core 210, and level 2 (L2) RAM 212. The peripherals 112 of FIG. 2 includes an example low voltage differential signaling (LVDS) circuitry, CSI2 214, example ethernet 216, example controller area network flexible data-rate (CAN-FD) circuitry 218, an example serial peripheral interface (SPI) 220, an example joint test action group (JTAG)/universal asynchronous receiver/transmitter (UART) circuitry 222, example real time interrupt (RTI) timers 224, an example frame/ramp timer 226, example miscellaneous peripheral components 228 230. Although the radar system 200 includes the particular processor cores 106 or peripherals 112 of FIG. 2, the processor cores 106 or peripherals may include additional or alternative components. Also, one or more of the processor cores 106 or peripherals 112 could be combined or removed.

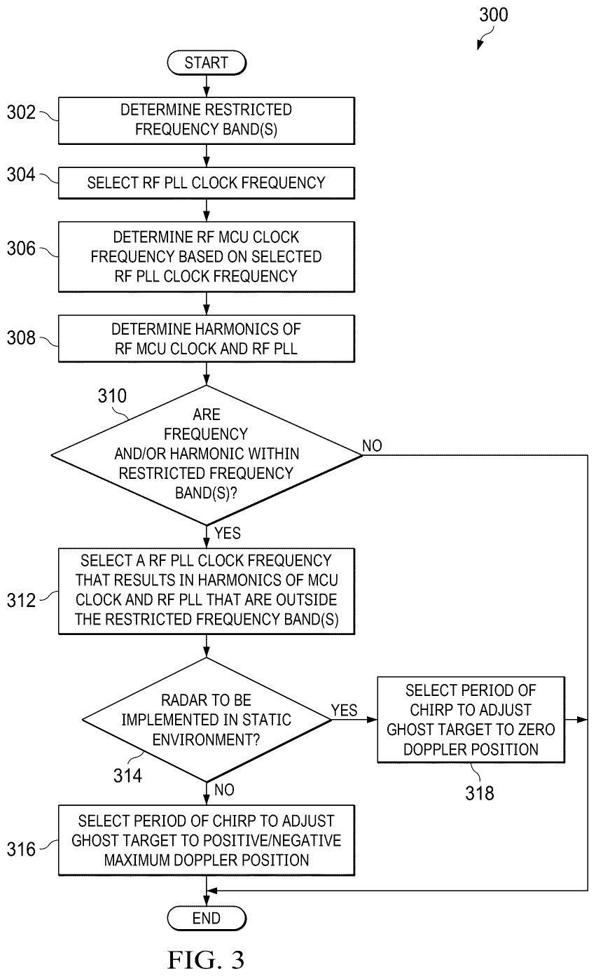

FIG. 3 is a flowchart representative of example machine-readable instructions or example operations 300 that may be at least one of executed, instantiated, or performed by programmable circuitry to select a clock signal frequency to be generated by the RF PLL 114 of FIG. 1 to avoid emissions within a restricted frequency band or to converse resources and select a chirp period to adjust a ghost target to a predefined doppler bin. The example machine-readable instructions or the example operations 300 of FIG. 3 begin at block 302, at which the application software processor core 142 determines the restricted frequency bans(s). For example, one or more standards may define the restricted frequency band(s) based on the where or how the radar system 100 is being implemented.

At block 304, the application software processor core 142 selects an RF PLL clock frequency. In some examples, the application software processor core 142 may initially select a RF PLL clock frequency that results in M(MCU_CLK)=N(XTAL_CLK), where M and N are integers (e.g., 1, 5 respectively), MCU_CLK is the frequency of the clock applied to the RF MCU processor core 146 and XTAL_CLK is the frequency of the clock signal generated by the oscillator 150. As described above, when M(MCU_CLK)=N(XTAL_CLK), there will be no ghost target. At block 306, the application software processor core 142 determines the RF MCU clock frequency based on the selected RF PLL clock frequency. For example, if the application software processor core 142 selects RF PLL clock frequency to be 14.4 GHZ, and the RF MCU clock frequency is configured to be the RF PLL clock frequency divided by 72, the application software processor core 142 determines that the RF MCU clock frequency to be 200 MHz (e.g., 14.4 GHz/72). Although FIG. 3 is described in conjunction with the RF MCU clock frequency, FIG. 3 may be described in conjunction with any clock signal generated by the clocking circuitry 102 of FIG. 1 or used by any component of the radar system 100. For example, FIG. 3 may be described in conjunction with a clock signal utilized by the ADCs 136, the FMCW PLL 120, one or more of the processor cores 106, or one or more of the peripherals 112 of FIG. 1 or 2.

At block 308, the application software processor core 142 determines the harmonics of the clock signal used by the RF MCU or the clock signal generated by the RF PLL. For example, if the RF MCU clock has a frequency of 200 MHz and the RF PLL has a frequency of 14.4 GHZ, the application software processor core 142 determines that the harmonics of the RF MCU clock signal are X(200 Mhz), where X is a positive integer, and the harmonics of the RF PLL clock signal are Y(14.4 GHZ), where Y is a positive integer. At block 310, the application software processor core 142 determines if the determined harmonics are within one or more restricted frequency band(s). A restricted frequency band may be a narrow frequency band that is restricted by a policy, standard, law, etc. An example restricted frequency band may be 1.6 GHz. If the application software processor core 142 determines that the frequency or harmonics of the RF PLL clock or the RF MCU clock is not within a restricted frequency band (block 310: NO), the instructions end. For example, a preset chirp period is selected and the application software processor core 142 instructs the RF PLL 114 or the FMCW PLL to generate signals based on the selected chirp period and the selected RF MCU clock frequency. If the application software processor core 142 determines that the frequency or harmonics of the RF PLL clock or the RF MCU clock is within a restricted frequency band (block 310: YES), the application software processor core 142 selects a RF PLL clock frequency that results in harmonics of the MCU clock and the RF PLL clock that are outside of the restricted frequency band(s) (block 312). The application software processor core 142 may select a frequency for the RF PLL that is close to the initially selected RF PLL that also generates clock signals with harmonics outside of the restricted band. For example, the further away from the initial RF PLL clock frequency, the higher the likelihood that the frequency divider circuitries 116, 118 will generate a clock with a frequency outside of the operation range of a corresponding component. Accordingly, the application software processor core 142 selects a RF PLL clock with a frequency that eliminates emissions outside of the restricted band and still results in clock signals within the operational limits of the respective components of the radar system 100. For example, the application software processor core 142 may select a RF PLL frequency of 14.32 GHZ), which will result in the RF MCU clock signal having a frequency of 198.89 MHz (e.g., 14.32 GHz/72). The harmonics of the RF MCU clock signal now correspond to X(198.89 MHz), which is outside of an example restricted frequency of 1.6 GHz (e.g., 198.89 MHz*8=1.591 GHz, which is outside of the 1.6 GHz restricted frequency band).

At block 314, the application software processor core 142 determines whether the radar is going to be implemented in a static environment. A static environment is an environment where most of the environment will remain static and only moving objects will be tracked. For example, a static environment may include using radar for in-cabin monitoring. A non-static environment is an environment where moving and non-moving objects will be tracked. For example, a non-static environment may include using radar for parking a vehicle. If the application software processor core 142 determines that the radar system 100 is to be implemented in a static environment (block 314: YES), the application software processor core 142 selects a period of the chirp signal to adjust the ghost target to a zero doppler position/bin (e.g., corresponding to a non-moving object) (block 318). For example, the range frequency offset of a ghost target is a function of a difference between the frequency of the clock signal from the oscillator 150 and the frequency of the clock signal used by the MCU processor core 146, as shown in the above Equation 1. Accordingly, based on the above-example data, without adjusting the period of the chirp a ghost target can appear at the frequency offset of 1.11 MHz (e.g., (5)(40 MHz)−(1)(198.89 MHz)=1.11 MHz) and a random doppler frequency depending on the chirp period. To adjust the doppler bin (frequency) of the ghost target, the application software processor core 142 adjusts the period of the chirp to R(1/(2*ghost_target_{range_offset}), where R is an even integer. As described above, using an even integer of R moves the ghost target to the zero-Doppler bin (e.g., zero frequency). Because the radar system 100 is implemented in a static environment, objects detected in the zero-Doppler bin will be filtered out.

If the application software processor core 142 determines that the radar system 100 is not to be implemented in a static environment (block 314: NO), the application software processor core 142 selects a period of the chirp signal to adjust the ghost target to a positive/negative maximum doppler position/bin (e.g., corresponding to an object of maximum velocity that the radar system 100 can detect) (block 316). For example, the frequency offset of a ghost target is a function of a difference between the frequency of the clock signal from the oscillator 150 and the frequency of the clock signal used by the MCU processor core X, as shown in the above Equation 1. Accordingly, based on the above-example data, without adjusting the period of the chirp a ghost target can appear at the frequency offset of 1.11 MHz (e.g., (5)(40 MHz)−(1)(198.89 MHz)=1.11 MHz) and a random doppler bin (frequency) depending on the chirp period. To adjust the doppler bin of the ghost target, the application software processor core 142 adjusts the period of the chirp to R(1/(2*ghost_target_{range_offset})), where R is an odd integer. As described above, using an odd integer of R moves the ghost target to the maximum positive or negative doppler bin. Because the radar system 100 is implemented in a non-static environment, maximum positive and negative doppler bins can be filtered out to remove the ghost target. After blocks 316, 317, the application software processor core 142 instructs the RF PLL 114 and the FMCW PLL 120 to generate signals based on the selected chirp period and the selected RF MCU clock frequency.

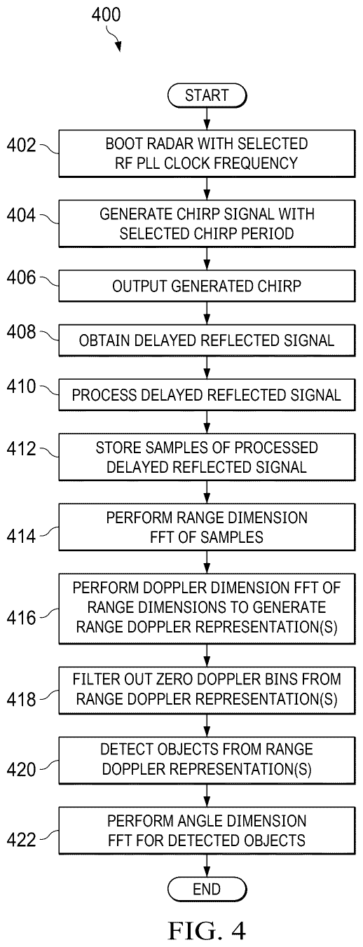

FIG. 4 is a flowchart representative of example machine-readable instructions or example operations 400 that may be at least one of executed, instantiated, or performed by programmable circuitry to operate the radar system 100 of FIG. 1 in a static environment. The example machine-readable instructions or the example operations 300 of FIG. 4 begin at block 402, at which the RF PLL 114 boots with selected RF PLL clock frequency. Accordingly, the RF PLL 114 is booted to generate a clock signal with the selected RF PLL clock frequency. As described above, the selected RF PLL clock frequency is selected to ensure no harmonic emissions corresponding to clock signals of the radar system 100 within one or more restricted frequency bands.

At block 404, the FMCW PLL 120 generates a chirp signal with the selected chirp period. As described above, the period of the chirp signal was selected to move a ghost target to the zero doppler bin. At block 406, the antennas 128 output the generated chirp signal. If an object is presented within a distance or velocity range, the chirp signal is reflected off of the object and obtained via the antennas 130. At block 408, the antennas 130 obtain the delayed reflected signal(s). At block 410, the amplifiers 132, mixer circuitries 134, ADCs 136, and filters 138 process the delayed reflected signal. For example, the amplifiers 132 amplified the delayed reflected signals, the mixer circuities 134 mix the delayed reflected signals with the chirp signal output by the multiplier 122, the ADCs 136 convert the analog signal into digital samples, and the filters 138 filter the digital samples.

At block 412, the RAM 140 stores the samples of the processed delayed reflected signals. At block 414, the radar data FTT compute processor core 144 performs range dimension FFT samples of the stored samples to determine the distance of an object corresponding to the reflected signal. At block 416, the radar data FTT compute processor core 144 performs a doppler dimension FFT of the range dimensions to generate range doppler representation(s). As further described above, the range doppler representation(s) may include a range-doppler heat map representation and a doppler dimension FFT representation. At block 418, the RF MCU core 146 filters out the zero doppler bin from the range doppler representations. Because the period of the chirp signal causes the ghost target to appear at the zero-doppler bin, filtering out the zero doppler bin removes the ghost target from the range doppler representation(s). At block 420, the RF MCU processor core 146 detects objects or velocity of objects from the range doppler representation(s). At block 422, the RF MCU processor core 146 performs angle dimension FFT for the detected objects. An angle dimension FFT identifies the angle of the object. An angle dimension FFT may be performed based on comparisons of the samples from the different digital filters 138, each corresponding to an antenna 130 at a different position, thereby resulting in information that can be processed to determine an angle of the object. After block 422, the RF MCU processor core 146 can output the analysis results (e.g., the detected objects, object velocities, angles, etc.) to the processing device 148 via the peripherals 112.

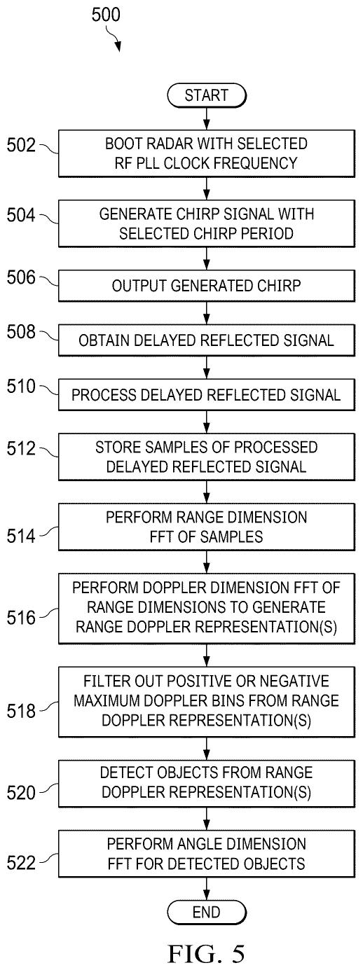

FIG. 5 is a flowchart representative of example machine-readable instructions or example operations 500 that may be at least one of executed, instantiated, or performed by programmable circuitry to operate the radar system 100 of FIG. 1 in a non-static environment. The example machine-readable instructions or the example operations 300 of FIG. 5 begin at block 502, at which the RF PLL 114 boots with selected RF PLL clock frequency. Accordingly, the RF PLL 114 is booted to generate a clock signal with the selected RF PLL clock frequency. As described above, the selected RF PLL clock frequency is selected to ensure no harmonic emissions corresponding to clock signals of the radar system 100 within one or more restricted frequency bands.

At block 504, the FMCW PLL 120 generates a chirp signal with the selected chirp period. As described above, the period of the chirp signal was selected to move a ghost target to the maximum positive or negative doppler bin. At block 506, the antennas 128 output the generated chirp signal. If an object is presented within a distance or velocity range, the chirp signal is reflected off of the object and obtained via the antennas 130. At block 508, the antennas 130 obtain the delayed reflected signal(s). At block 510, the amplifiers 132, mixer circuitries 134, ADCs 136, and filters 138 process the delayed reflected signal. For example, the amplifiers 132 amplified the delayed reflected signals, the mixer circuities 134 mix the delayed reflected signals with the chirp signal output by the multiplier 122, the ADCs 136 convert the analog signal into digital samples, and the filters 138 filter the digital samples.

At block 512, the RAM 140 stores the samples of the processed delayed reflected signals. At block 514, the radar data FTT compute processor core 144 performs range dimension FFT samples of the stored samples to determine the distance of an object corresponding to the reflected signal. At block 516, the radar data FTT compute processor core 144 performs a doppler dimension FFT of the range dimensions to generate range doppler representation(s). As further described above, the range doppler representation(s) may include a range-doppler heat map representation and a doppler dimension FFT representation. At block 518, the RF MCU core 146 filters out the maximum positive and negative doppler bins from the range doppler representations. Because the period of the chirp signal causes the ghost target to appear at one of the maximum doppler bins, filtering out the maximum positive and negative doppler bins removes the ghost target from the range doppler representation(s). At block 520, the RF MCU processor core 146 detects objects or velocity of objects from the range doppler representation(s). At block 522, the RF MCU processor core 146 performs angle dimension FFT for the detected objects. An angle dimension FFT identifies the angle of the object. An angle dimension FFT may be performed based on comparisons of the samples from the different digital filters 138, each corresponding to an antenna 130 at a different position, thereby resulting in information that can be processed to determine an angle of the object. After block 522, the RF MCU processor core 146 can output the analysis results (e.g., the detected objects, object velocities, angles, etc.) to the processing device 148 via the peripherals 112.

FIGS. 6A-6C illustrate examples of range doppler representations. FIG. 6A includes a first range doppler representation 600 and a second range doppler representation 602 where M(MCU_CLK)≠N(XTAL_CLK) and the period of the chirp signal has not been adjusted. FIG. 6B includes a first range doppler representation 604 and a second range doppler representation 606 where M(MCU_CLK)≠N(XTAL_CLK) and the period of the chirp signal has been adjusted to move the ghost target to the maximum positive or negative doppler bin. FIG. 6C includes a first range doppler representation 606 and a second range doppler representation 608 where M(MCU_CLK)≠N(XTAL_CLK) and the period of the chirp signal has been adjusted to move the ghost target to the zero doppler bin.

In FIG. 6A, the first range doppler representation 600 is a visual representation of a range doppler heat map and the second range doppler representation 602 is a visual representation of doppler dimension FFT. In the first range doppler representation 600, there is an indication 601a of an object at approximately 0 Hz and there is an indication 601b of an object at approximately 1500 Hz. The 0 Hz indication 601a corresponds to an actual target object that is static. The 1500 Hz indication 601b corresponds to a ghost target traveling at a particular frequency. The second range doppler representation 602 includes a peak at the 0 Hz and the 1500 Hz, as shown at the example indication 603a, 603b. Even though the doppler representations 600, 602 reflect an object moving at a particular velocity, the object is a target object that is not actually there.

In FIG. 6B, the first range doppler representation 604 is a visual representation of a range doppler heat map and the second range doppler representation 606 is a visual representation of doppler dimension FFT. In the first range doppler representation 604, there is an indication 605a of an object at approximately 0 Hz and there is an indication 605b of an object at approximately −3500 Hz, the maximum negative doppler bin. The 0 Hz indication 605a corresponds to an actual target object that is static. The −3500 Hz indication 605b corresponds to a ghost target that has been moved to the maximum negative doppler bin by adjusting the period of the chirp, as further described above. The second range doppler representation 606 includes a peak at the 0 Hz and the −3500 Hz, as shown at the example indication 607a, 607b. As further described above in FIG. 5, the ghost target is filtered out for use of the radar system 100 in non-static environments.

In FIG. 6C, the first range doppler representation 608 is a visual representation of a range doppler heat map and the second range doppler representation 610 is a visual representation of doppler dimension FFT. In the first range doppler representation 608, there is an indication 609 of an object at approximately 0 Hz, the zero frequency/doppler bin. The 0 Hz indication 609 corresponds to a ghost target that has been moved to the zero frequency/doppler bin by adjusting the period of the chirp, as further described above. As further described above in conjunction with FIG. 4, the ghost target is filtered out for use of the radar system 100 in static environments.

FIG. 7 illustrates a timing diagram 700 corresponding to an example chirp signal 701 that may be generated by the FMCW PLL 120 of FIG. 1 or 2. The chirp signal 701 increases from a first frequency (e.g., 76 GHZ) to a second frequency (e.g., 80 GHz) and then increases back down and repeats. The period of the chirp signal 701 corresponds to the duration of time it takes to repeat the changing of the chirp signal 701 (e.g., the amount of time between neighboring peaks). As described above, the chirp periodicity is selected to move a ghost target to a predefined doppler bin(s) that is filtered out.

FIG. 8 is a block diagram of an example programmable circuitry platform 800 structured to one or a combination of execute or instantiate one or more of the example machine-readable instructions or the example operations of FIGS. 3-5 to implement one or more components of the radar system 100, 200 of FIG. 1 or 2. The programmable circuitry platform 800 can be, for example, a server, a personal computer, a computing system for a vehicle (e.g., an automobile), a workstation, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, or microcontrollers from any desired family or manufacturer. The programmable circuitry 812 may be implemented by one or more semiconductor based (e.g., silicon based) devices. In this example, the programmable circuitry 812 implements the one or more components of the radar system 100, 200 of FIG. 1 or 2.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 816 may be implemented by one or a combination of flash memory or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter one of or a combination of data or commands into the programmable circuitry 812. The input device(s) 822 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 824 are also connected to the interface circuitry 820 of the illustrated example. The output device(s) 824 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 820 of the illustrated example, thus, includes one of or a combination of a graphics driver card, a graphics driver chip, or graphics processor circuitry such as a GPU.

The interface circuitry 820 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store one or more firmware, software, or data. Examples of such mass storage discs or devices 828 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 832, which may be implemented by the machine-readable instructions of FIGS. 3-5, may be stored in one of or a combination of the mass storage device 828, in the volatile memory 814, in the non-volatile memory 816, or on at least one non-transitory computer readable storage medium such as a CD or DVD which may be removable.

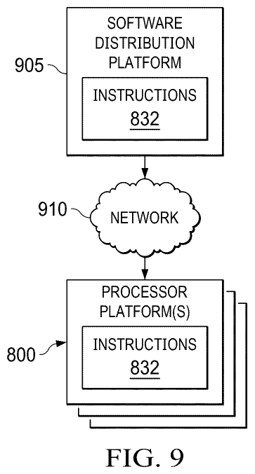

A block diagram illustrating an example software distribution platform 905 to distribute software such as the example machine-readable instructions 832 of FIG. 8 to other hardware devices (e.g., one or more hardware devices owned or operated by third parties from the owner or operator of the software distribution platform) is illustrated in FIG. 9. The example software distribution platform 905 may be implemented by any computer server, data facility, cloud service, etc., capable of storing and transmitting software to other computing devices. The third parties may be customers of the entity at least one of owning or operating the software distribution platform 905. For example, the entity that at least one of owns or operates the software distribution platform 905 may be at least one of a developer, a seller, or a licensor of software such as the example machine-readable instructions 832 of FIG. 8. The third parties may be consumers, users, retailers, OEMs, etc., who one of or a combination of purchase or license the software for at least one of use, re-sale, or sub-licensing. In the illustrated example, the software distribution platform 905 includes one or more servers and one or more storage devices. The storage devices store the machine-readable instructions 832, which may correspond to the example machine-readable instructions of FIGS. 3-5, as described above. The one or more servers of the example software distribution platform 905 are in communication with an example network 910, which may correspond to any one or more of the Internet or any of the example networks described above. In some examples, the one or more servers are responsive to requests to transmit the software to a requesting party as part of a commercial transaction. Payment for at least one of the delivery, sale, or license of the software may be handled by the one or more servers of at least one of the software distribution platform or by a third-party payment entity. The servers enable one or more purchasers or licensors to download the machine-readable instructions 832 from the software distribution platform 905. For example, the software, which may correspond to the example machine-readable instructions of FIGS. 3-5, may be downloaded to the example programmable circuitry platform 800, which is to execute the machine-readable instructions 832 to implement the radar system 100. In some examples, one or more servers of the software distribution platform 905 periodically at least one of offer, transmit, or force updates to the software (e.g., the example machine-readable instructions 832 of FIG. 8) to ensure improvements, patches, updates, etc., are distributed and applied to the software at the end user devices. Although referred to as software above, the distributed “software” could alternatively be firmware.

While an example manner of implementing the radar systems 100, 200 of FIG. 1 or 2 is illustrated in FIG. 1 or 2, one or more of the elements, processes, or devices illustrated in FIG. 1 or 2 may be combined, divided, re-arranged, omitted, eliminated, or implemented in any other way. Further, the components of the radar system 100, 200 of FIG. 1 or 2, may be implemented by hardware alone or by hardware in combination with software and firmware. Thus, for example, any of the components of the radar system 100, or, more generally, the example radar system 100, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example radar system 100, 200 of FIG. 1 or 2 may include one or more elements, processes, or devices in addition to, or instead of, those illustrated in FIG. 1 or 2, or may include more than one of any or all of the illustrated elements, processes and devices.

Flowchart(s) representative of example machine-readable instructions, which may be executed by programmable circuitry to at least one of implement or instantiate the radar system 100, 200 of FIG. 1 or 2 or representative of example operations which may be performed by programmable circuitry to at least one of implement or instantiate the radar system 100, 200 of FIG. 1 or 2, are shown in FIGS. 3-5. The machine-readable instructions may be one or more executable programs or portion(s) of one or more executable programs for execution by programmable circuitry such as the programmable circuitry 612 shown in the example processor platform 800 discussed above in connection with FIG. 8 and may be one or more function(s) or portion(s) of functions to be performed by the example programmable circuitry (e.g., an FPGA). In some examples, the machine-readable instructions cause an operation, a task, etc., to be carried out or performed in an automated manner in the real-world. As used herein, “automated” means without human involvement.

The program may be embodied in instructions (e.g., at least one of software or firmware) stored on one or more non-transitory computer readable or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-5, many other methods of implementing the example radar system 100 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). For example, the programmable circuitry may be one of or a combination of a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, or executable by a computing device or other machine. For example, the machine-readable instructions may be stored in multiple parts, which are individually compressed, encrypted, or stored on separate computing devices, wherein the parts responsive to being decrypted, decompressed, or combined from a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-5 may be implemented using executable instructions (e.g., computer readable or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

One or more example manners of implementing the radar system 100, 200 of FIG. 1 or 2 is illustrated in FIG. 1 or 2. However, one or more of the elements, processes or devices illustrated in FIG. 1 or 2 may be combined, divided, re-arranged, omitted, eliminated or implemented in any other way.

Further, one or more of the processor cores 106 or other components of the radar system 100, 200 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) or field programmable logic device(s) (FPLD(s)).

When reading any of the apparatus or system claims of this patent to cover a purely software or firmware implementation, at least one of the processor cores 104 or any component of the radar system 100 is/are hereby expressly defined to include a non-transitory computer readable storage device or storage disk such as a memory, a digital versatile disk (DVD), a compact disk (CD), a Blu-ray disk, etc., including the software or firmware. Further still, one or more of one or more of the processor cores 106 or the components of the radar system 100 may include one or more elements, processes or devices in addition to, or instead of, those illustrated in FIGS. 1-2, or may include more than one of any or all of the illustrated elements, processes, and devices. As used herein, the phrase “in communication,” including variations thereof, encompasses direct communication or indirect communication through one or more intermediary components, and does not require direct physical (e.g., wired) communication or constant communication, but rather also includes selective communication at one or more of periodic intervals, scheduled intervals, aperiodic intervals, or one-time events.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

Descriptors “first,” “second,” “third,” etc. are used herein to identify multiple elements or components which may be referred to separately. Unless otherwise specified or known based on their context of use, such descriptors do not impute any meaning of priority, physical order, or arrangement in a list, or ordering in time but are merely used as labels for referring to multiple elements or components separately for ease of understanding the described examples. In some examples, the descriptor “first” may be used to refer to an element in the detailed description, while the same element may be referred to in a claim with a different descriptor such as “second” or “third.” In such instances, such descriptors are used merely for ease of referencing multiple elements or components.

The terms “couple,” “coupled,” “couples,” and variants thereof, as used herein, may cover connections, communications, or signal paths that enable a functional relationship consistent with this description. For example, if device A generates a signal to control device B to perform an action, if a first example device A is coupled to device B, or if a second example device A is coupled to device B through intervening component C if intervening component C does not substantially alter the functional relationship between device A and device B, such that device B is controlled by device A via the control signal generated by device A. Moreover, the terms “couple,” “coupled”, “couples”, or variants thereof, includes an indirect or direct electrical or mechanical connection.

Although not all separately labeled in the FIGS. 1-2, components or elements of systems and circuits illustrated therein have one or more conductors or terminus that allow signals into or out of the components or elements. The conductors or terminus (or parts thereof) may be pins, pads, terminals (including input terminals, output terminals, reference terminals, and ground terminals, for instance), inputs, outputs, nodes, and interconnects.

The term “or” as used, for example, in a form such as A, B, or C refers to any combination or subset of A, B, C such as (1) A alone, (2) B alone, (3) C alone, (4) A with B, (5) A with C, (6) B with C, or (7) A with B and with C.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture corresponding to a sensor system operating with multiple clock frequencies are described herein. Further examples and combinations thereof include the following: Example 1 includes a system comprising a radio frequency (RF) phase-locked loop (PLL) to generate an output signal at a first frequency, a microcontroller to operate at a second frequency, the first frequency being a multiple of the second frequency, a transmitter to output a chirp signal with a chirp period selected based on the second frequency, a receiver to receive a reflected signal corresponding to the chirp signal, and a filter to filter out a doppler bin corresponding to the reflected signal based on the chirp period.

Example 2 includes the system of example 1, wherein harmonics of the first frequency and harmonics of the second frequency are outside of a restricted frequency band.

Example 3 includes the system of example 1, wherein the RF PLL is to generate the output signal at the first frequency based on a clock signal at a third frequency lower than the first frequency.

Example 4 includes the system of example 3, wherein the chirp period is also selected based on the third frequency.

Example 5 includes the system of example 1, further including a processor core to generate a range doppler representation based on the reflected signal, the range doppler representation including doppler bins that correspond to different velocities.

Example 6 includes the system of example 5, wherein a mismatch corresponding to the second frequency and a third frequency of a clock signal used to generate the first frequency results in a ghost target in the range doppler representation at a particular range-doppler bin.

Example 7 includes the system of example 1, further including a frequency divider to generate a clock signal at the second frequency based on the output signal, the microcontroller to use the clock signal to operate.

Example 8 includes the system of example 1, wherein the doppler bin corresponds to a maximum positive or negative velocity capable of being detected by the system.

Example 9 includes the system of example 1, wherein the doppler bin corresponds to zero velocity.

Example 10 includes the system of example 1, wherein the system is a system-on-chip.

Example 11 includes the system of example 1, further including a processor core to select the chirp period to move a ghost target to a particular doppler bin in a range doppler representation, which doppler bin may be determined prior to operation.

Example 12 includes a method comprising generating an output signal at a first frequency, operating a core at a second frequency, the first frequency being a multiple of the second frequency, outputting a chirp signal with a chirp period selected based on the second frequency, receiving a reflected signal corresponding to the chirp signal, and filtering out a doppler bin corresponding to the reflected signal based on the chirp period.

Example 13 includes the method of example 12, wherein harmonics of the first frequency and harmonics of the second frequency are outside of a restricted frequency band.

Example 14 includes the method of example 12, further including generating the output signal at the first frequency based on a clock signal at a third frequency lower than the first frequency.

Example 15 includes the method of example 14, wherein the chirp period is also selected based on the third frequency.

Example 16 includes the method of example 12, further including generating a range doppler representation based on the reflected signal, the range doppler representation including doppler bins that correspond to different velocities.

Example 17 includes the method of example 16, wherein a mismatch corresponding to the second frequency and a third frequency of a clock signal used to generate the first frequency results in a ghost target in the range doppler representation at a particular range-doppler bin.

Example 18 includes the method of example 12, further including generating a clock signal at the second frequency based on the output signal, the core to use the clock signal to operate.

Example 19 includes the method of example 12, wherein the doppler bin corresponds to a maximum positive or negative velocity capable of being detected by a radar system.

Example 20 includes the method of example 12, wherein the doppler bin corresponds to zero velocity.

Example 21 includes the method of example 12, further including selecting the chirp period to move a ghost target to a particular doppler bin in a range doppler representation, which doppler bin may be determined prior to operation.

Example 22 includes a non-transitory computer readable storage medium comprising instructions to cause at least one programmable circuit to at least select a first frequency of a first clock signal to be generated by a radio frequency (RF) phase-locked loop (PLL), the first clock signal used to generate a second clock signal at a second frequency, the first frequency selected based on harmonics of the first clock signal and harmonics of the second clock signal, select a chirp period of a chirp signal to be output by a transmitter of radar, the chirp period of the chirp signal based on the second frequency of the second clock signal, cause a phase-locked loop to generate the first clock signal at the first frequency, and cause a transceiver to output the chirp signal based on the selected period.

Example 23 includes the non-transitory computer readable storage medium of example 22, wherein one or more of the at least one programmable circuit is to select the first frequency to ensure that the harmonics of the first clock signal and the second clock signal are outside of a restricted frequency band.

Example 24 includes the non-transitory computer readable storage medium of example 22, wherein the second frequency is the first frequency divided by an integer.

Example 25 includes the non-transitory computer readable storage medium of example 22, wherein the chirp period is selected based on a third frequency of third clock signal of an oscillator.

Example 26 includes the non-transitory computer readable storage medium of example 22, wherein one or more of the at least one programmable circuit is to select the chirp period to move a ghost target to a particular doppler bin in a range doppler representation, which doppler bin may be determined prior to operation.

Modifications are possible in the described examples, and other examples are possible, within the scope of the claims.

1. A system comprising:
a radio frequency (RF) phase-locked loop (PLL) to generate an output signal at a first frequency;
a microcontroller to operate at a second frequency, the first frequency being a multiple of the second frequency;
a transmitter to output a chirp signal with a chirp period selected based on the second frequency;
a receiver to receive a reflected signal corresponding to the chirp signal; and
a filter to filter out a doppler bin corresponding to the reflected signal based on the chirp period.

2. The system of claim 1, wherein harmonics of the first frequency and harmonics of the second frequency are outside of a restricted frequency band.

3. The system of claim 1, wherein the RF PLL is to generate the output signal at the first frequency based on a clock signal at a third frequency lower than the first frequency.

4. The system of claim 3, wherein the chirp period is also selected based on the third frequency.

5. The system of claim 1, further including a processor core to generate a range doppler representation based on the reflected signal, the range doppler representation including doppler bins that correspond to different velocities.

6. The system of claim 5, wherein a mismatch corresponding to the second frequency and a third frequency of a clock signal used to generate the first frequency results in a ghost target in the range doppler representation at a particular range-doppler bin.

7. The system of claim 1, further including a frequency divider to generate a clock signal at the second frequency based on the output signal, the microcontroller to use the clock signal to operate.

8. The system of claim 1, wherein the doppler bin corresponds to a maximum positive or negative velocity capable of being detected by the system.

9. The system of claim 1, wherein the doppler bin corresponds to zero velocity.

10. The system of claim 1, wherein the system is a system-on-chip.

11. The system of claim 1, further including a processor core to select the chirp period to move a ghost target to a doppler bin in a range doppler representation.

12. A method comprising:
generating an output signal at a first frequency;
operating a core at a second frequency, the first frequency being a multiple of the second frequency;
outputting a chirp signal with a chirp period selected based on the second frequency;
receiving a reflected signal corresponding to the chirp signal; and
filtering out a doppler bin corresponding to the reflected signal based on the chirp period.

13. The method of claim 12, wherein harmonics of the first frequency and harmonics of the second frequency are outside of a restricted frequency band.

14. The method of claim 12, further including generating the output signal at the first frequency based on a clock signal at a third frequency lower than the first frequency.

15. The method of claim 14, wherein the chirp period is also selected based on the third frequency.

16. (canceled)

17. (canceled)

18. (canceled)

19. (canceled)

20. (canceled)

21. (canceled)

22. A non-transitory computer readable storage medium comprising instructions to cause at least one programmable circuit to at least:
select a first frequency of a first clock signal to be generated by a radio frequency (RF) phase-locked loop (PLL), the first clock signal used to generate a second clock signal at a second frequency, the first frequency selected based on harmonics of the first clock signal and harmonics of the second clock signal;
select a chirp period of a chirp signal to be output by a transmitter of radar, the chirp period of the chirp signal based on the second frequency of the second clock signal;
cause a phase-locked loop to generate the first clock signal at the first frequency; and
cause a transceiver to output the chirp signal based on the selected period.

23. The non-transitory computer readable storage medium of claim 22, wherein one or more of the at least one programmable circuit is to select the first frequency to ensure that the harmonics of the first clock signal and the second clock signal are outside of a restricted frequency band.

24. The non-transitory computer readable storage medium of claim 22, wherein the second frequency is the first frequency divided by an integer.

25. The non-transitory computer readable storage medium of claim 22, wherein the chirp period is selected based on a third frequency of third clock signal of an oscillator.

26. The non-transitory computer readable storage medium of claim 22, wherein one or more of the at least one programmable circuit is to select the chirp period to move a ghost target to a doppler bin in a range doppler representation.
